(19) United States
(12) Patent Application Publication
(10) Pub. No.: US 2013/0108054 A1
(43) Pub. Date: May 2, 2013

(54) METHOD AND DEVICE FOR PRODUCING A DOWNWARD COMPATIBLE SOUND FORMAT

(71) Applicant: Jens Groh, Munchen (DE)

(72) Inventor: Jens Groh, Munchen (DE)

(73) Assignee: INSTITUT FUR RUNDFUNKTECHNIK GMBH, Munchen (DE)

(21) Appl. No.: 13/642,326

(22) PCT Filed: Apr. 13, 2011
(86) PCT No.: PCT/EP2011/055780

§ 371 Date: Dec. 21, 2012

(30) Foreign Application Priority Data
Apr. 20, 2010 (DE) 10 2010 015 630.2

(51) Int. Cl. H04R 5/04

(52) U.S. Cl. CPC H04R 5/04
USPC 381/17

(57) ABSTRACT

In order to reduce the disturbing background noises that may arise during the summation with weighting of the spectral coefficients using a correction factor in a downmix method, the proposition is made that the correction factors m(k) are computed as follows:

eA(k)=Real(A(k))Real(A(k))+Imag(A(k))·Imag(A(k))

eB(k)=Real(B(k))·Real(B(k))+Imag(B(k))·Imag(B(k))

x(k)=Real(A(k))·Real(B(k))+Imag(A(k))·Imag(B(k))

w(k)=D·x(k)/(eA(k)+L·eB(k))

m(k)=(w(k)²+1)^{(1/2)}−w(k)

wherein
m is the k^{th} correction factor;
   and
A(k) is the k^{th} spectral value of the signal to be prioritized;
   and
B(k) is the k^{th} spectral value of the signal not to be prioritized;
   and
D is the degree of compensation;
   and
L is the degree of the limitation of the compensation.

The invention relates to a method according to the preamble portion of the patent claim 1. Such a method is known from the prior application DE 10 2008 056 704.

For radio, internet, and at home in the field of audio, the 5.1 sound format is nowadays also applied next to two channel stereo and mono. Due to the increase of available sound formats, the effort for audio productions for recording and mixing into the corresponding sound format increases consequently. Also, compatibility to the playback devices must be ensured so that these may play back each sound format independently of the number of audio channels.

In order to cover all audio formats, a possibility exists to transmit the audio format with the highest number of audio channels and to convert the reception signal into a sound format with a lower number of audio channels on the receiver side (referred to as automatic downmix).

Alternatively, already during the audio production, the sound material may be produced in all formats, and these may be broadcasted in parallel (referred to as simulcast).

Hereby, the generation of each sound format may occur separately. This type of mixing, however, requires a significant production effort. For this purpose, either additional workforces, distinctly higher time investments, or multiple types of equipment (for example, in the case of live transmissions) are necessary most of the time. Accordingly, automatic downmix is cheaper. Such a method for automatic conversion is known from the prior DE 10 2008 056 704.

For the known automatic downmix methods according to the prior DE 10 2008 056 704, down mixing is provided for the generation of a two channel sound format from a multi-channel (for example, five-channel) sound format. Thereby, phantom sound sources may be imaged, wherein both the shift of the phantom sound sources and the sound changes due to comb filter effects are compensated to a large extent.

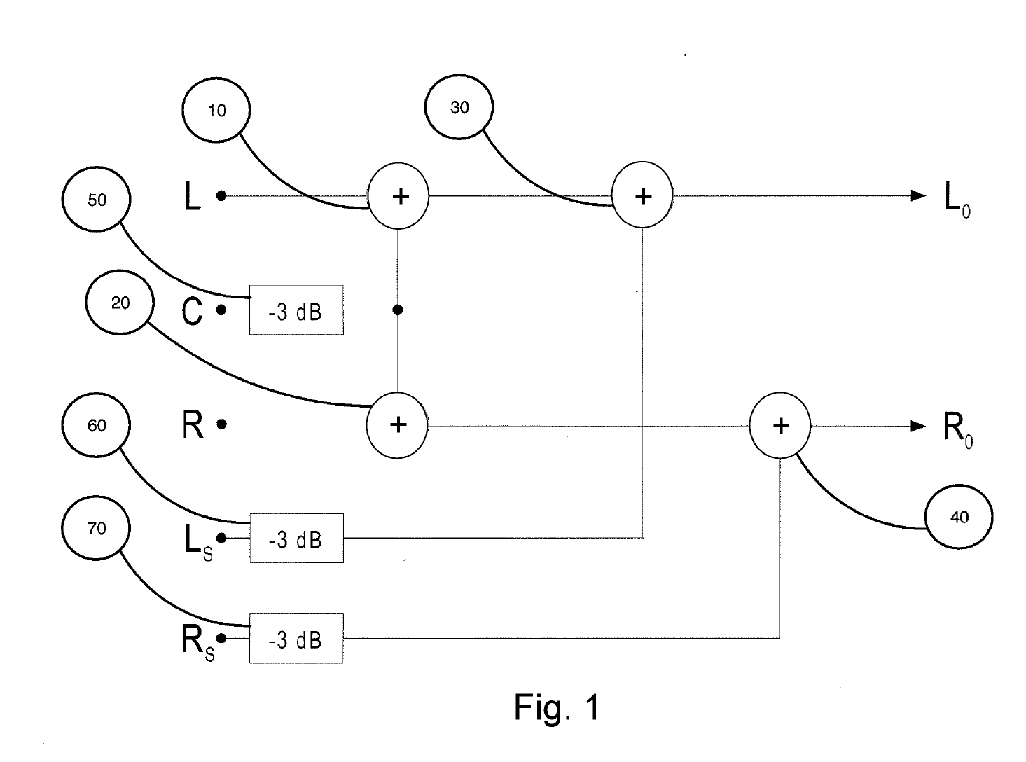

The known method according to DE 10 2008 056 704 is explained more detail with regard to an embodiment example shown in the FIGS. 1 to 6.

The FIG. 1 shows a general overview of the structure of the known method,

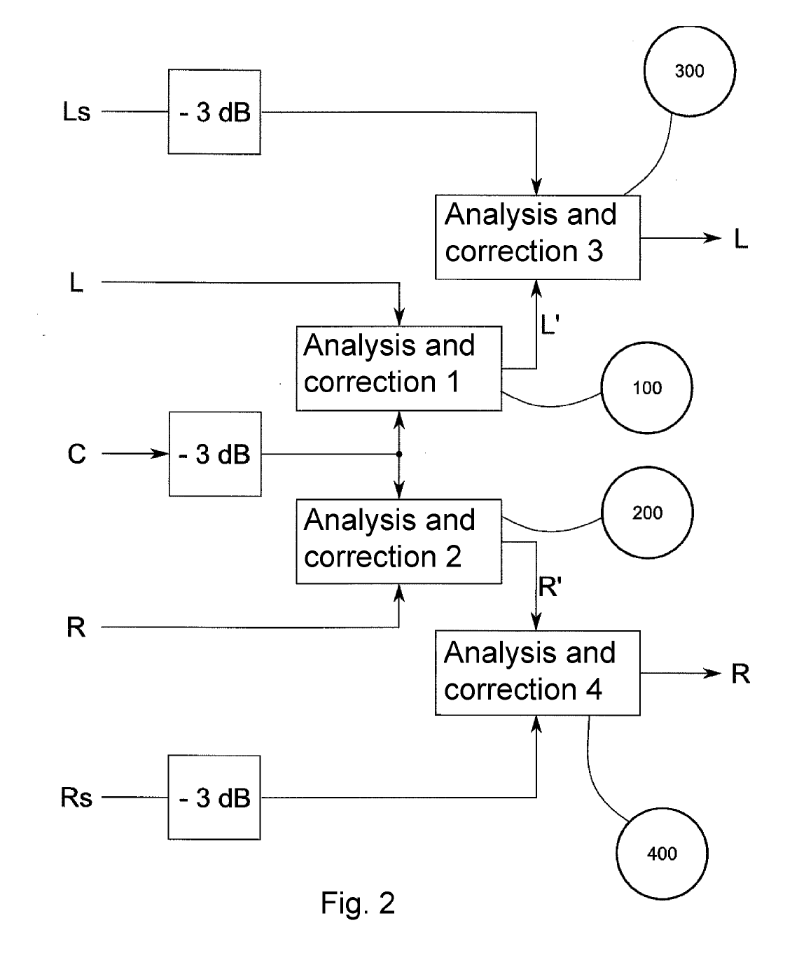

FIG. 2 a block diagram for an assembly for performing the known method, and the

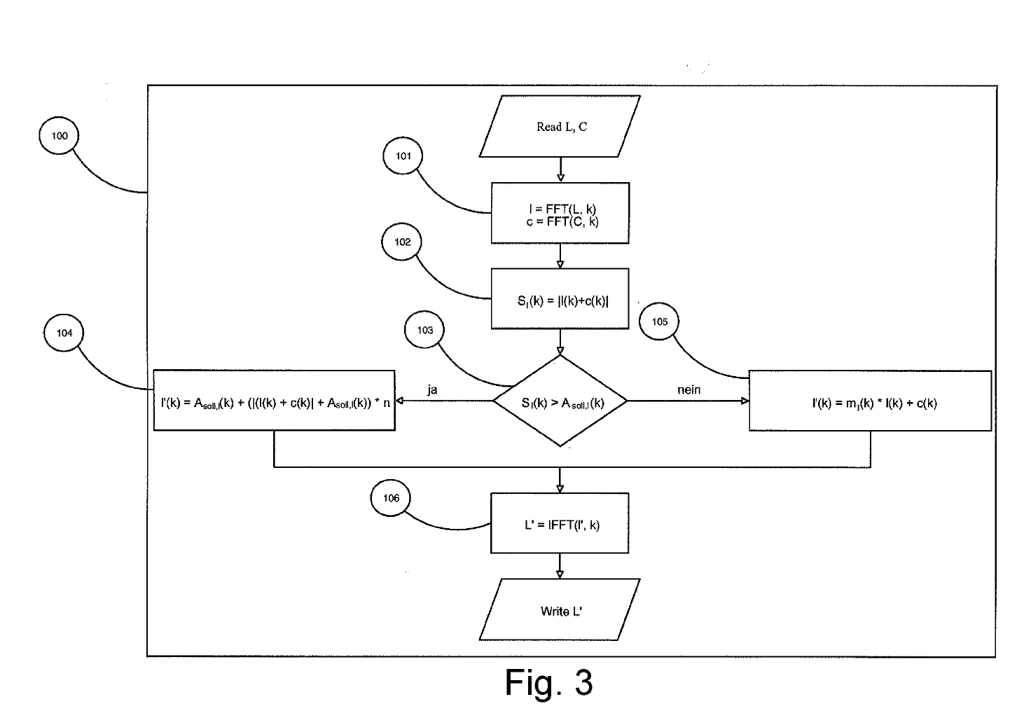

FIGS. 3 to 6 flow diagrams for the functions provided in the analysis and correction blocks.

Starting from a five-channel sound format with the sound channels
left channel (L)
right channel (R)
centre channel (C)
left back channel (Ls)
right back channel (Rs),
   the known downmix method, as shown in FIG. 1, at first provides a reduction of the level of the centre channel C, and of the left back channel LS, and of the right back channel RS by −3 dB each by means of the damping function 50 and 60 and 70, respectively. The centre channel reduced by −3 dB is distributed onto the left channel L and the right channel R by means of the summation functions 10 and 20, respectively, by forming a first sum signal (summation functions 10 output) and a second sum signal (summation functions 20 output). The left back and right back channels Ls and Rs, respectively, reduced by −3 dB with regard to level are distributed onto the first and the second sum signal, respectively, by means of the summation functions 30 and 40, respectively, by forming of the left and right channel L₀, R₀ of the desired two-channel sound format.

For the known downmix method, in the summation functions of the block diagram according to FIG. 1, the properties of the audio signals to be summed up are verified and, if necessary, corrected in order to avoid undesired sound results.

Thereby, the spectral components are analyzed and corrected. In this way, increases and decreases of the energy content may be determined and compensated by means of amplitude correction in the relevant sub-bands. A tone color change due to a comb filter effect may be limited accordingly. The correction, however, is performed only up to a reasonable degree because a signal cancelling itself completely would cause an infinitively large correction factor. Hereby, shifts of the phantom sound source between the resulting left and right channels of the two channel sound format may arise in dependency of the original position of the phantom sound source in the five-channel source material.

The block diagram illustrated in FIG. 2 is structured in a manner similar to the block diagram in FIG. 1 comprising, however, the significant difference that, in addition to the summation, an analysis and correction 1-4 is performed in the summation functions 100 and 200 for the forming of the first and the second sum signals L′ and R′ as well as in the summation functions 300 and 400 for forming the left and right signals L_{IRT} and R_{IRT} of the two-channel sound format. Due to the damping functions 50, 60, and 70, respectively, the level reduction of the centre signal C as well as of the right back and left back signals Ls, Rs is, for example, −3 dB for the block diagram 2 in accordance with the block diagram according to FIG. 1. However, other damping than −3 dB is possible, in particular in dependency of the genre or content of the five-channel source signal.

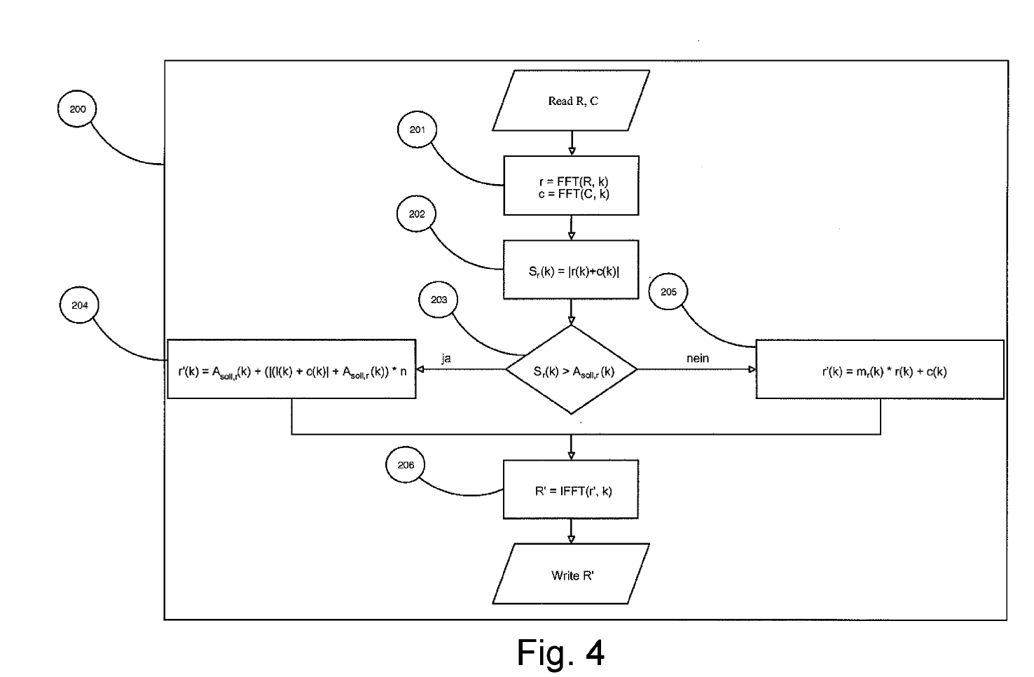

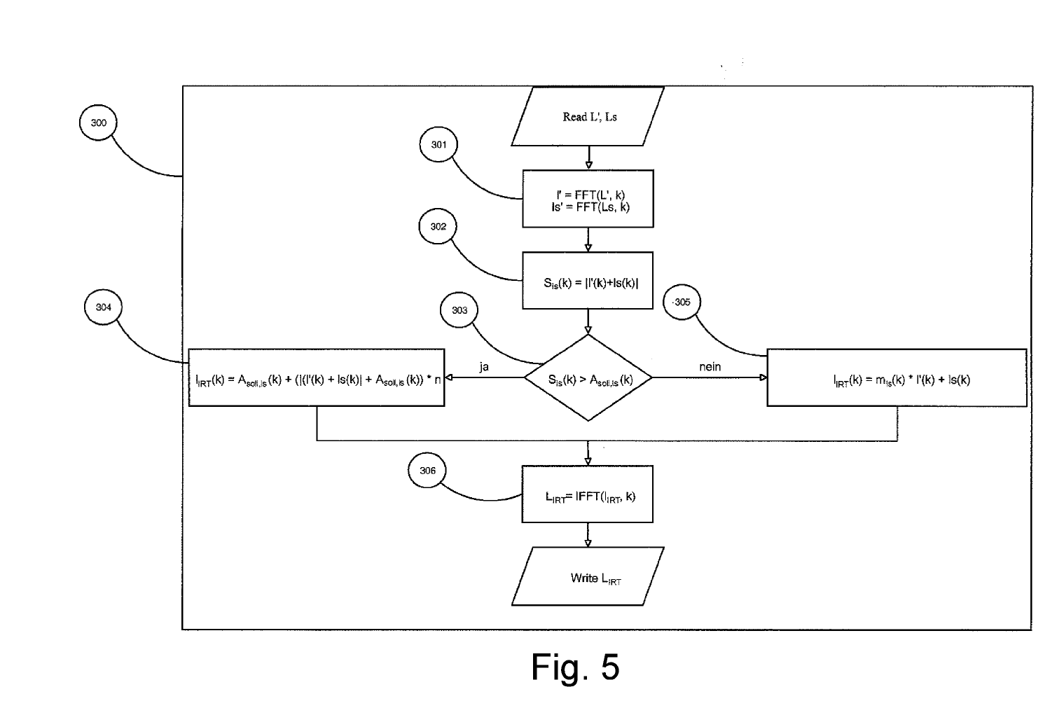

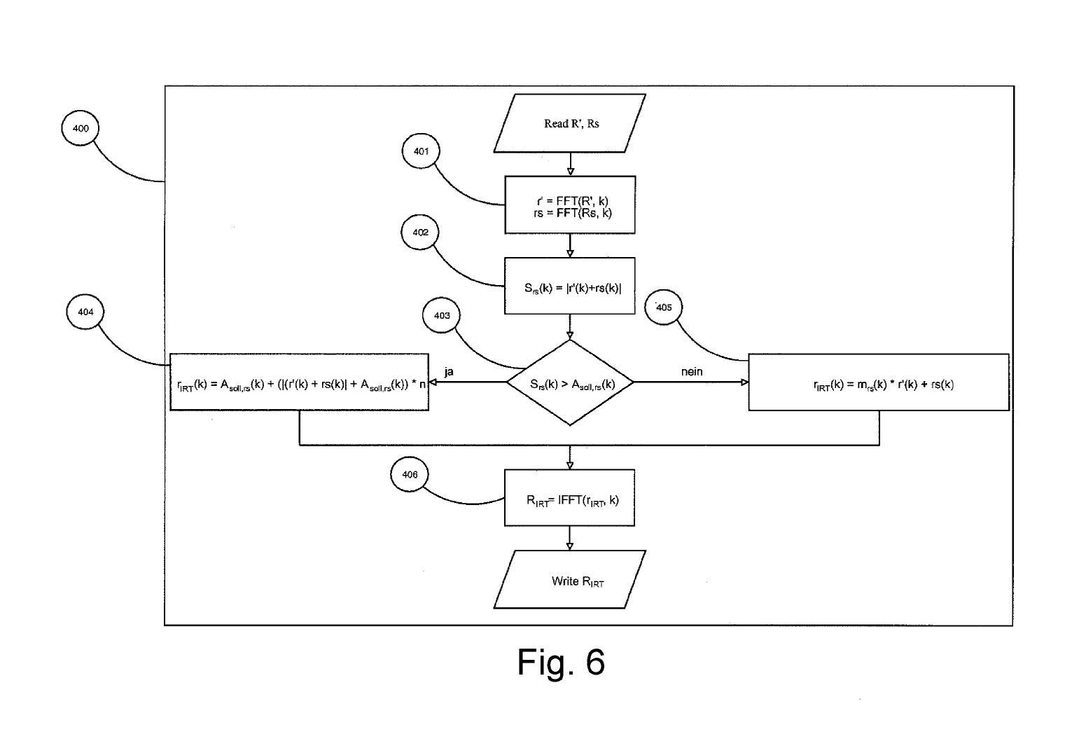

The functional structure of the analysis and correction blocks 100, 200, 300, 400 in FIG. 2 is described with regard to FIG. 3 for block 100, with regard to FIG. 4 for block 200, with regard to FIG. 5 for block 300, and with regard to FIG. 6 for block 400.

The block 100 illustrated in FIG. 3 at first provides a transformation of the input side left and centre signal, L and C, into spectral values, for example, by means of a FFT 101. The formed spectral values l(k), c(k) are added in the summing function 102. In the decision rhombus 103, the absolute sum Sₗ(k) of the spectral values is subsequently evaluated in view of whether it is larger than a nominal value A_{soll,l}(k). The nominal value A_{soll,l}(k) is determined from

A_{soll,l}(k)=\sqrt{|1(k)|²+|c(k)|²}

In case the absolute sum is larger than A_{soll,l}(k), then the value

l′(k)=A_{soll,l}(k)+(|l(k)+c(k)|−A_{soll,l}(k))*n

is formed in block 104, wherein n is a factor larger than 0.1 and smaller than 0.4. In case the absolute value is not larger than the nominal value A_{soll,l}(k), then the spectral values l(k) of the left channel are weighted using a factor mₗ(k) in block 105. The factor mₗ(k) is larger than one and is used for level adjustment just as the factor n mentioned previously. The product mₗ(k)*l(k) is added to the spectral values c(k) of the centre channel (mₗ(k)*1+c).

As a result, in the block 100, by means of the decision rhombus 103, the signal l′(k) adjusted with regard to the level is either formed according to mₗ(k)*l(k)+c(k) or A_{soll,l}(k)+(l(k)+c(k)|−A_{soll,l}(k))*n, which yields the first sum signal L′ following an inverse transformation 106.

The block 200 illustrated in FIG. 4 at first provides a transformation of the input side right and centre signal, T and C, into spectral values, for example, by means of a FFT 201. The formed spectral values r(k), c(k) are added in the summing function 202. In the decision rhombus 203, the absolute sum Sᵣ(k) of the spectral values is subsequently evaluated in view of whether it is larger than a nominal value A_{soll,r}(k). The nominal value A_{soll,r}(k) is determined from

A_{soll,r}(k)=\sqrt{|r(k)|²+|c(k)|²}

In case the absolute sum is larger than S_{soll,r}(k), then the value

r′(k)=A_{soll,r}(k)+(|r(k)+c(k)|−A_{soll,r}(k))*n

is formed in block 204, wherein n is a factor larger than 0.1 and smaller than 0.4. In case the absolute value is not larger than the nominal value A_{soll,r}(k), then the spectral values r(k) of the right channel are weighted using a factor mᵣ(k) in block 205. The factor mᵣ(k) is larger than one and is used for level adjustment just as the factor n mentioned previously. The product mᵣ(k)*r(k) is added to the spectral values c(k) of the centre channel (mᵣ(k)*r(k)+c(k)).

As a result, in the block 200, by means of the decision rhombus 203, the signal r′(k) adjusted with regard to the level is either formed according to mᵣ(k)*r(k)+c(k) or A_{soll,r}(k)+|r(k)+c(k)|−A_{soll,r}(k))*n, which yields the second sum signal R′ following an inverse transformation 206.

The block 300 illustrated in FIG. 5 at first provides a transformation of the input side left back signal and first sum signal, Ls and L′, into spectral values, for example, by means of a FFT 301. The formed spectral values ls(k), l′(k) are added in the summing function 302. In the decision rhombus 303, the absolute sum Sₗₛ(k) of the spectral values is subsequently evaluated in view of whether it is larger than a nominal value A_{soll,ls}(k). The nominal value A_{soll,ls}(k) is determined from

A_{soll,ls}(k)=\sqrt{|ls(k)|²+|l′(k)|²}

In case the absolute sum is larger than A_{soll,ls}(k), then the value

l_{IRT}(k)=A_{soll,ls}(k)+(|ls(k)+l′(k)|−A_{soll,ls}(k))*n

is formed in block 304, wherein n is a factor larger than 0.1 and smaller than 0.4. In case the absolute value is not larger than the nominal value A_{soll,ls}(k), then the spectral values l′(k) of the first sum signal are weighted using a factor mₗₛ(k) in block 305. The factor mₗₛ(k) is larger than one and is used for level adjustment just as the factor n mentioned previously. The product mₗₛ(k)*l′(k) is added to the spectral values ls(k) of the left back channel (mₗₛ(k)*l′(k)+ls(k)).

As a result, in the block 300, by means of the decision rhombus 303, the signal adjusted with regard to the level is either formed according to mₗₛ(k)*l′(k)+ls(k) or A_{soll,ls}(k)+(|l′(k)+ls(k)|−A_{soll,ls}(k))*n, which yields the third sum signal and thus the left output signal L following an inverse transformation 306.

The block 400 illustrated in FIG. 6 at first provides a transformation of the input side right back signal and second sum signal, Rs and R′, into spectral values, for example, by means of a FFT 401. The formed spectral values rs(k), r′(k) are added in the summing function 402. In the decision rhombus 403, the absolute sum Sᵣₛ(k) of the spectral values is subsequently evaluated in view of whether it is larger than a nominal value A_{soll,rs}(k). The nominal value A_{soll,rs}(k) is determined from

A_{soll,rs}(k)=\sqrt{|rs(k)|²+|r′(k)|²}

In case the absolute sum is larger than A_{soll,rs}(k), then the value

r_{IRT}(k)=A_{soll,rs}(k)+(|rs(k)+r′(k)|−A_{soll,rs}(k))*n

is formed in block 304, wherein n is a factor larger than 0.1 and smaller than 0.4. In case the absolute value is not larger than the nominal value A_{soll,rs}(k), then the spectral values r′(k) of the first sum signal are weighted using a factor mᵣₛ(k) in block 405. The factor mᵣₛ(k) is again larger than one and is used for level adjustment just as the factor n mentioned previously. The product mᵣₛ(k)*r′(k) is added to the spectral values rs(k) of the right back channel (mᵣₛ(k)*r′(k)+rs(k)).

As a result, in the block 400, by means of the decision rhombus 403, the signal adjusted with regard to the level is either formed according to mᵣₛ(k)*r′(k)+rs(k) or A_{soll,rs}(k)+(|r′(k)+rs(k)|A_{soll,rs}(k))*n, which yields the fourth sum signal and thus the right output signal R following an inverse transformation 406.

In the summation functions of the block diagram according to FIG. 2, in each case, the input signal of the summation that is weighted by the correction factor is prioritized against the other input signal. In the summation function 100, L is the prioritized input signal; in the summation function 200, R is the prioritized input signal, in the summation signal 300, L′ is the prioritized input signal; in the summation signal 400, R′ is the prioritized input signal.

The determination of the correction factor described in the DE 10 2008 056 704, however, results in that disturbing background noise may become audible in cases in that the amplitude of the prioritized signal is low with regard to the one of the non-prioritized signal. Although the probability of the occurrence of such disturbances is low; however, it is not controllable for a given compensation effect. If the compensation effect is reduced by reducing the scaling value w, then the disturbing background noise is lowered; however, correspondingly more of the undesired sound changes remain.

The problem to be solved by the invention is to reduce the disturbing background noises, which may arise during the summation including weighting of the spectral coefficients with a correction factor.

The above described problems are solved by the method according to the attached claim 1.

Advantageous embodiments and developments of the method according to claim 1 follow from the dependent claims.

The invention also relates to a device for the implementation of the method, according to claim 6.

The invention is based on the idea that the compensation of the comb filter effect by means of a weighting of spectral coefficients leads to a discontinuity in the corrected signal that is audible as a background noise whenever the amplitude of the coefficient of the prioritized signal is low with regard to the coefficient of the non-prioritized signal. The probability that such a case arises is given for most occurring signals. In case a type of computation is used in the computing unit for correction factor values wherein the degree of compensation depends on the relation of the amplitude of the prioritized signal with regard to the non-prioritized signal, then, in total, the discontinuity may be faded out and a high degree of compensation effect may be achieved all at the same. In this way, the disturbing background noises may be reduced without the effect that the undesired sound changes increase significantly.

For this purpose in all summing stages, the correction factor values m(k) are computed in the corresponding computing unit for correction factors as follows:

eA(k)=Real(A(k))Real(A(k))+Imag(A(k))·Imag(A(k))

eB(k)=Real(B(k))·Real(B(k))+Imag(B(k))·Imag(B(k))

x(k)=Real(A(k))·Real(B(k))+Imag(A(k))·Imag(B(k))

w(k)=D·x(k)/(eA(k)+L·eB(k))

m(k)=(w(k)²+1)^{(1/2)}−w(k)

wherein

m(k) is the k^{th} correction factor;

A(k) is the k^{th} spectral value of the signal to be prioritized;

B(k) is the k^{th} spectral value of the signal not to be prioritized;

D is the degree of compensation; and

L is the degree of the limitation of the compensation.

The degree D of the compensation is a numerical value determining to which degree the sound changes caused by the comb filter effect are compensated. It lies within the range from 0 to 1. In case D=0, then no compensation of the sound changes due to comb filter effects occurs. In case D=1, then a far-reaching compensation of the sound changes due to comb filter effects occurs.

The degree L of the limitation of the compensation is a numerical value determining to which degree the probability of the occurrence of disturbingly perceivable background noises are reduced. L>=0 is valid. In case L=0, then no reduction of the probability of the disturbing background noises occurs. The degree L is chosen so that, according to experience, background noises are just not perceivable anymore. The larger the degree L is, the smaller becomes the probability of the disturbance; however, thereby, the compensation of sound changes determined by the setting of D is also partially reduced.

Typically, the degree L is of the order of 0.5.

Further implementation details will not be described, as the man skilled in the art is able to carry out the invention starting from the teaching of the above description.

The method of the present invention can be advantageously implemented through a program for computer comprising program coding means for the implementation of one or more steps of the method, when this program is running on a computer. Therefore, it is understood that the scope of protection is extended to such a program for computer and in addition to a computer readable means having a recorded message therein, said computer readable means comprising program coding means for the implementation of one or more steps of the method, when this program is run on a computer.

Many changes, modifications, variations and other uses and applications of the subject invention will become apparent to those skilled in the art after considering the specification and the accompanying drawings which disclose preferred embodiments thereof. All such changes, modifications, variations and other uses and applications which do not depart from the spirit and scope of the invention are deemed to be covered by the following claims.

1. A method for producing a downward compatible sound format with a right channel (R_{IRT}) and a left channel (L_{IRT}), from a multi-channel sound format with the following sound channels:
left channel (L)
right channel (R)
centre channel (C)
left back channel (Ls)
right back channel (Rs)
wherein
the centre channel (C) is reduced with regard to level
the centre channel (C) reduced with regard to level is distributed onto the left channel by forming a first sum signal (L′)
the left back channel (Ls) is reduced with regard to level
the left back channel (Ls) reduced with regard to level is distributed onto the first sum signal by forming the third sum signal, which corresponds to the left channel (L_{IRT}) of the two-channel sound format
the centre channel (C) reduced with regard to level is distributed onto the right channel (R) by forming a second sum signal (R′),
the right back channel (Rs) is reduced with regard to level,
the right back channel (Rs) reduced with regard to level is distributed onto the second sum signal by forming a fourth sum signal, which corresponds to the right channel (R_{IRT}) of the two-channel sound format,
for forming the first (L′) and second (R′) sum signal, a dynamic correction of the spectral values of overlapping time windows with k scan values of the left channel (L) and right channel (R), respectively, is performed in each case,
for forming the third and fourth sum signal, a dynamic correction of the spectral values of overlapping time windows with k scan values of the first (L′) and second (R′) sum signal, respectively, is performed in each case,
prior to each dynamical correction of spectral values of the left channel (L) and right channel (R), each sum of the spectral values is compared to a nominal value (Aₛₒₗₗ), which follows from the following relation:
A_{soll,l}(k)=\sqrt{|l(k)|²+|c(k)|²} and
A_{soll,r}(k)=\sqrt{|r(k)|²+|c(k)|²}
in which

|l(k)| is the absolute value of a spectral value of the transformed left channel (L) in the complex plane,

|c(k)| is the absolute value of the corresponding spectral value of the transformed centre channel (L) in the complex plane,

|r(k)| is the absolute value of a spectral value of the transformed right channel (R) in the complex plane,
prior to each dynamical correction of spectral values of the first (L′) and second (R′) sum signal, each sum of the spectral value is compared to a nominal value (Aₛₒₗₗ), which follows from the following relation:
A_{Soll,ls}(k)=\sqrt{|l′(k)²+|ls(k)|²} and
A_{Soll,rs}(k)=\sqrt{|r′(k)²+|rs(k)|²}
in which

|r′(k)| is the absolute value of the spectral values of the transformed third sum signal (R′) in the complex plane,

|l′(k)| is the absolute value of the corresponding spectral value of the transformed first sum signal (L′) in the complex plane,

|rs(k)| is the absolute value of the spectral value of the transformed right back channel Rs in the complex plane,

|ls(k)| is the absolute value of the corresponding spectral value of the transformed left back channel Ls in the complex plane,
in the case that the nominal value (A_{Soll}) is exceeded, the frequency component is summed up and the resulting absolute value is reduced according to S(k)=A_{Soll}(k)+|A(k)+B(k)|−Aₛₒₗₗ(k))*n, and
in the case that the nominal value (ASoll) is not exceeded, the spectral values of corresponding signals to be corrected is multiplied with a factor (m(k)),
characterized in that the correction factors m(k) are computed as follows:
eA(k)=Real(A(k))Real(A(k))+Imag(A(k))·Imag(A(k))
eB(k)=Real(B(k))·Real(B(k))+Imag(B(k))·Imag(B(k))
x(k)=Real(A(k))·Real(B(k))+Imag(A(k))·Imag(B(k))
w(k)=D·x(k)/(eA(k)+L·eB(k))
m(k)=(w(k)²+1)^{(1/2)}−w(k)
wherein
m(k) is the k^{th} correction factor; and
A(k) is the kth spectral value of the signal to be prioritized; and
B(k) is the kth spectral value of the signal not to be prioritized; and
D is the degree of compensation; and
L is the degree of the limitation of the compensation.

2. The method according to claim 1, characterized in that the value for the degree D lies in the range from 0 to 1, wherein no compensation of the sound changes due to comb filter effects results for D=0, and a far-reaching compensation of the sound changes due to comb filter effects results for D=1.

3. The method according to claim 1, characterized in that the degree L of the limitation of the compensation is a numerical value that determines to which degree the probability of the occurrence of disturbing perceivable background noises is reduced, wherein this probability is given if the amplitude of the signal to be prioritized is small with regard to the signal not to be prioritized.

4. The method according to claim 3, characterized in that the degree L of the limitation is larger or equal to zero, wherein no reduction of the probability of the disturbing background noises results for L=0, and the degree L is chosen so that, according to experience, background noises are just not perceivable anymore.

5. The method according to claim 3, characterized in that the degree L of the limitation of the compensation is of the order of 0.5.

6. A device for producing a downward compatible sound format, comprising means for the implementation of the method as in claim 1.

7. Computer program comprising computer program code means adapted to perform all the steps of the method of claim 1, when said program is run on a computer.

8. A computer readable medium having a program recorded thereon, said computer readable medium comprising computer program code means adapted to perform all the steps of the method of claim 1, when said program is run on a computer.
